(19) United States
(12) Patent Application Publication
(10) Pub. No.: US 2006/0254424 A1
(43) Pub. Date: Nov. 16, 2006

(54) Method and system of purging water in air dryer of air pressure circuit

(75) Inventor: Tetsuo Sadachika, Tsukubamirai-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: SMC Corporation, Chiyoda-ku (JP)

(21) Appl. No.: 11/407,142

(22) Filed: Apr. 20, 2006

(30) Foreign Application Priority Data
May 11, 2005 (JP) 2005-138849

(51) Int. Cl. B01D 53/02

(52) U.S. Cl. 96/108

(57) ABSTRACT

To provide a method and a system of purging water in an air dryer that can effectively dehumidify compressed air only by utilizing a small amount of secondary compressed air dehumidified by the air dryer as purge air. In an air pressure circuit having an compressed air source, an air pressure cylinder driven by the compressed air supplied from the compressed air source, a switching valve for supplying and exhausting the compressed air to a pressure chamber of the air pressure cylinder, and an air dryer interposed between the compressed air source and an inlet port of the switching valve, the compressed air from the compressed air source is dehumidified in the air dryer, a part of the dehumidified secondary compressed air is caused to flow together with the air discharged from the air pressure cylinder, and the air flowing together is supplied to a purge flow path of the air dryer as purge air.

### TECHNICAL FIELD

The present invention relates to a water purge method for discharging the water separated from compressed air in an air dryer of an air pressure circuit for driving an air pressure actuator by compressed air supplied from a compressed air source and to a water purge system of the air dryer of the air pressure circuit making use of it.

### BACKGROUND ART

An air pressure circuit as disclosed in, for example, Patent Document 1 is known as an air pressure circuit for driving an air pressure actuator by the compressed air supplied from a compressed air source.

Air pressure circuits of this type dispose a membrane type air dryer between an air source and an inlet port of a switching valve to dehumidify air by a membrane module and connect an exhaust port of the switching valve a purge flow path of the membrane type air dryer. With this arrangement, since dehumidified air can be entirely used to drive the air pressure actuator, the dehumidified air is not wastefully consumed, which is effective in that a running cost of the air pressure circuit can be significantly reduced.

By the way, a problem of dew condensation in actuators is arisen by recent reduction in size of the actuators. In general, dews are condensed in an actuator when the volume of it is made smaller than the volume of a piping in a certain degree or more. More specifically, the temperature of compressed air is reduced when it is expanded at the time it is exhausted, and when the temperature is reduced blow a dew point, mists are generated. Almost all the mists are evaporated and exhausted. However, when there is a factor for preventing mists from being exhausted such as a small volume of an actuator, a long piping length, and the like, the mists are gradually condensed and grown into water, from which dews are generated in the actuator.

It is contemplated to reduce the dew point of compressed air as a countermeasure for the dew condensation in the actuator. However, since the membrane type air dryer generally requires a larger flow amount of purge air as a dew point is more reduced, there is contemplated a case in which a stable flow amount of purge air cannot be secured only by the air exhausted from the actuator.

Japanese Utility Model Gazette No. 2502135

### DISCLOSURE OF THE INVENTION

In view of the problem described above, a technical object of the present invention is to provide a method and a system of purging water in an air dryer of an air pressure circuit that can effectively dehumidify the compressed air supplied from a compressed air source by utilizing a small amount of secondary compressed air dehumidified in the air dryer.

To solve the above problem, in a method of purging water in an air dryer of an air pressure circuit of the present invention having a compressed air source, an air pressure actuator driven by the compressed air supplied from the compressed air source, a switching valve for supplying and exhausting the compressed air of the compressed air source to and from at least one pressure chamber of the air pressure actuator, and an air dryer interposed between the compressed air source and an inlet port of the switching valve, the method is characterized by including dehumidifying the primary compressed air supplied from the compressed air source in the air dryer, and causing a part of the secondary compressed air dehumidified by the air dryer to flow together with the air discharged from the air pressure actuator and discharging the water separated from the compressed air in the air dryer using the air flowing together as purge air.

Further, in a system of purging water in an air dryer of an air pressure circuit, which has a compressed air source, an air pressure actuator driven by the compressed air supplied from the compressed air source, and a switching valve for supplying and exhausting the compressed air of the compressed air source to and from at least one pressure chamber of the air pressure actuator, making use of the above method, the system is characterized in that an air dryer is interposed between the compressed air source and an inlet port of the switching valve, a part of the secondary compressed air of the air dryer is caused to flow together with the air discharged from the air pressure actuator, and a piping is provided to use the air flowing together as purge air for discharging the water separated in the air dryer.

In the system of purging water in the air dryer, the air dryer in the air pressure circuit may be composed of a membrane type air dryer for dehumidifying air by a membrane module. Further, it is effective to dispose a discharge path to a piping from an exhaust port of the switching valve to a purge flow path of the air dryer to discharge a part of exhaust air to the outside so that an increase in the back pressure of the cylinder can be suppressed. Further, it is possible to cause the air dryer to act as a silencer in an exhaust portion from the air pressure actuator.

In the method and the system of the present invention, a part of the secondary compressed air of the air dryer (5 to 10% of the flow amount of inlet air) is caused to flow as the purge air at all times, and, at the same time, the air exhausted from the actuator is entirely or partly caused to flow together with the compressed air and used as the purge air. Accordingly, almost all the dehumidified air can be effectively utilized without being wasted as compared with a conventional ordinary air dryer which uses only the secondary compressed air of an air dryer (10 to 40% of the flow amount of inlet air) as purge air.

Further, in the air dryer of Patent Document 1, since purge air is obtained only when the air pressure actuator exhausts air, there is a possibility that a necessary amount of purge air cannot be obtained when it is necessary depending on a driving state of the air pressure actuator. However, in the present invention, the problem can be avoided because the purge air flows at all times although it is small in amount.

As described above in detail, according to the present invention, a small amount of the secondary compressed air dehumidified in the air dryer is caused to flow together with the air exhausted from air pressure actuator, and the air flowing together is used as purge air to discharge the water separated from the compressed air in the dryer. As a result, the compressed air supplied from the compressed air source can be effectively dehumidified only by utilizing a small amount of the secondary compressed air dehumidified in the air dryer as the purge air, thereby a dew point can be reduced.

### BRIEF DESCRIPTION OF THE DRAWINGS

FIG. 1 is a circuit diagram conceptually showing an embodiment of a water purge system of an air dryer according to the present invention.

### BEST MODE FOR CARRYING OUT THE INVENTION

The present invention will be explained in more detail based on an embodiment shown in the figure.

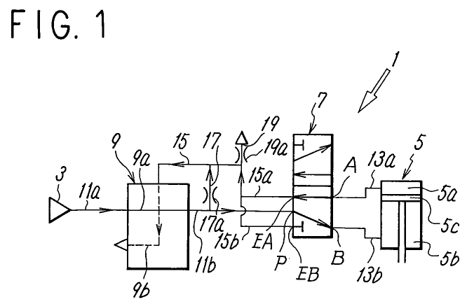

FIG. 1 conceptually shows an embodiment of a system for purging water in an air dryer of an air pressure circuit according to the present invention. The air pressure circuit 1 includes a compressed air source 3 composed of an air compressor and the like, an air pressure cylinder 5 as an example of an actuator driven by the compressed air supplied from the compressed air source 3, and a switching valve 7 for supplying and exhausting the compressed air, which is supplied from the compressed air source 3, to and from pressure chambers 5a, 5b on both the sides of a piston 5c of the air pressure cylinder 5. Then, a membrane type air dryer 9 is interposed between the compressed air source 3 and an inlet port P of the switching valve 7. The membrane type air dryer 9 dehumidifies the compressed air supplied from the compressed air source through a membrane module 9a.

The switching valve 7 is composed of 5 ports switching valve having the inlet port P, outlet ports A, B and exhaust ports EA, EB and supplies and exhausts the compressed air from the compressed air source 3 to and from the pressure chambers 5a, 5b of the air pressure cylinder 5 by switching the outlet ports A, B to the inlet port P and the exhaust ports EA, EB and causing them to communicate with each other.

The compressed air source 3 is connected to the inlet port P of the switching valve 7 through the membrane module 9a of the membrane type air dryer 9. In the figure, reference numerals 11a, 11b show pipings for connecting them. Further, the outlet ports A, B of the switching valve 7 are connected to pipings 13a, 13b communicating with the pressure chambers 5a, 5b of the air pressure cylinder 5, and the switching valve 7 is switched and connected by an appropriate switching means such as a solenoid and the like. Further, pipings 15a, 15b connected to the exhaust ports EA, EB of the switching valve 7 are connected to a purge flow path 9b of the membrane type air dryer 9 through a piping 15 to which the pipings 15a, 15b are connected.

Further, a piping 17 branched from the secondary piping 11b of the membrane type air dryer 9 is connected to the piping 15 that communicates the exhaust ports EA, EB of the switching valve 7 with the purge flow path 9b of the membrane type air dryer 9. With this arrangement, a part of the secondary compressed air dehumidified by the membrane type air dryer 9 is caused to flow together with a part of the air discharged from the air pressure cylinder and used as purge air for discharging the water separated in the membrane type air dryer 9. Although the amount of the secondary compressed air of the membrane type air dryer 9 to be mixed with the purge air can be adjusted by a diaphragm 17a disposed to the piping 17, it is ordinarily set to about 5 to 10% of a flow amount of inlet air.

To prevent an increase of the pack pressure of the air pressure cylinder 5, a discharge path 19 may be disposed to the piping 15 from the exhaust port of the switching valve 7 to the purge flow path 9b of the air dryer 9 to exhaust a part of the air discharged from the air pressure cylinder 5 to the outside through a diaphragm 19a.

Next, an operation of the air pressure circuit 1 making use of the system will be explained together with a water pure method of the air dryer 9 in the circuit.

First, the primary compressed air supplied from the compressed air source 3 is dehumidified by the membrane type air dryer 9. The dehumidified compressed air reaches the switching valve 7 through the secondary piping 11b of the air dryer 9 and is supplied to the pressure chamber 5a or 5b of the air pressure cylinder 5 by switching the switching valve 7. In contrast, the compressed air discharged from the other pressure chamber of the air pressure cylinder 5 is supplied to the purge flow path 9b of the air dryer 9 through the piping 15. However, since a part of the secondary compressed air passing through the secondary piping 11b of the air dryer 9 is supplied to the piping 15 through the piping 17 branched from the piping 11b, the air discharged from the air pressure cylinder 5 flows together with a part of the secondary compressed air of the air dryer 9 and is supplied to the purge flow path 9b, thereby the water separated from the compressed air by the membrane module 9a of the air dryer 9 is purged.

Note that it is effective to dispose the discharge path 19 to the piping 15 from the exhaust ports EA, EB of the switching valve 7 to the purge flow path 9b of the air dryer 9 to discharge a part of exhaust air to the outside so that the increase in the back pressure of the air pressure cylinder 5 can be suppressed. Further, it is also possible to cause the air dryer 9 to act as a silencer in an exhaust portion from the air pressure cylinder 5.

Further, when only the air exhausted from the air pressure cylinder 5 is used as the purge air, there is a possibility that a necessary amount of purge air cannot be obtained when the purge air is necessary depending on a driving state of the air pressure cylinder 5. According to the above arrangement, however, this drawback can be avoided because the purge air flows from the secondary side of the air dryer 9 flows at all times although it is small in amount.

According to the water purge system of the air dryer having the above arrangement and the water purge method of the air dryer making use of the system, a small amount of the secondary compressed air dehumidified by the air dryer 9 is caused to flow together with the air discharged from the air pressure cylinder 5 and used as the purge air for purging the water separated from the compressed air in the air dryer 9. Accordingly, it is only required to use a small amount of the secondary compressed air of the air dryer as the purge air, thereby the dew point of the compressed air supplied from the compressed air source 3 can be reduced.

A case in which the air pressure cylinder 5 is used as the air pressure actuator is explained in the embodiment described above. However, the method and the system of the present invention can be applied to any air pressure circuit having various types of air pressure actuators which are driven by compressed air supplied thereto and discharge the compressed air used to drive the actuator.

Further, the air dryer is not limited to the membrane type air dryer and an adsorption type air dryer can be also used.

1. A method of purging water in an air dryer of an air pressure circuit comprising a compressed air source, an air pressure actuator driven by the compressed air supplied from the compressed air source, a switching valve for supplying and exhausting the compressed air of the compressed air source to and from at least one pressure chamber of the air pressure actuator, and an air dryer interposed between the compressed air source and an inlet port of the switching valve, characterized in that:
the primary compressed air supplied from the compressed air source is dehumidified by the air dryer, and
a part of the secondary compressed air dehumidified by the air dryer is caused to flow together the air discharged from the air pressure actuator and the water separated from the compressed air in the air dryer is discharged using the air flowing together as purge air.

2. A system of purging water in an air dryer of an air pressure circuit having a compressed air source, an air pressure actuator driven by the compressed air supplied from the compressed air source, and a switching valve for supplying and exhausting the compressed air of the compressed air source to and from at least one pressure chamber of the air pressure actuator, characterized in that:
an air dryer is interposed between the compressed air source and an inlet port of the switching valve, a part of the secondary compressed air of the air dryer is caused to flow together with the air discharged from the air pressure actuator, and a piping is provided to use the air flowing together as purge air for discharging the water separated in the air dryer.

3. A system of purging water in an air dryer of an air pressure circuit according to claim 2, characterized in that the air dryer of the air pressure circuit comprises a membrane type air dryer for dehumidifying air by a membrane module.

4. A system of purging water in an air dryer of an air pressure circuit according to claim 2, characterized in that a discharge path is disposed to a piping from an exhaust port of the switching valve to a purge flow path of the air dryer to discharge a part of exhaust air to the outside.

5. A system of purging water in an air dryer of an air pressure circuit according to claim 3, characterized in that a discharge path is disposed to a piping from an exhaust port of the switching valve to a purge flow path of the air dryer to discharge a part of exhaust air to the outside.

6. A system of purging water in an air dryer of an air pressure circuit according to claim 2, characterized in that the air dryer is caused to act as a silencer in an exhaust portion from the air pressure actuator.

7. A system of purging water in an air dryer of an air pressure circuit according to claim 3, characterized in that the air dryer is caused to act as a silencer in an exhaust portion from the air pressure actuator.

8. A system of purging water in an air dryer of an air pressure circuit according to claim 4, characterized in that the air dryer is caused to act as a silencer in an exhaust portion from the air pressure actuator.

9. A system of purging water in an air dryer of an air pressure circuit according to claim 5, characterized in that the air dryer is caused to act as a silencer in an exhaust portion from the air pressure actuator.
